(19) United States
(12) Patent Application Publication
(10) Pub. No.: US 2010/0060657 A1
(43) Pub. Date: Mar. 11, 2010

(54) DIGITAL PHOTO FRAME FOR DISPLAYING IMAGE AND METHOD THEREOF

(75) Inventors: MING-FENG TSAI, Tu-Cheng (TW); CHENG-HAO CHOU, Tu-Cheng (TW); KUAN-HONG HSIEH, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/485,051

(22) Filed: Jun. 16, 2009

(30) Foreign Application Priority Data
Sep. 8, 2008 (CN) 200810304403.X

(51) Int. Cl. G09G 5/00

(52) U.S. Cl. 345/581; 345/619

(57) ABSTRACT

A digital photo frame capable of displaying images is provided. The digital photo frame includes a display, a user input unit, a memory, and a processor. The memory is configured for storing images, types of frames, and display modes, wherein each of the display modes defines a total display area count of images displayable on the display, types of frames assigned to each display area, and a predetermined display manner. The processor includes: a reading module configured for obtaining images and the display modes from the memory, an assigning module is configured for configuring one or more display areas on the display according to the total display area count defined in the display mode, and assigning the display areas with different frames; and a displaying module configured for displaying the images in the display area assigned with different frames according to the display mode.

### BACKGROUND

1. Technical Field

The disclosure relates to a digital photo frame for displaying images and a method thereof.

2. Description of Related Art

Digital images play an important role in the lives of many people, and digital photo frames are capable of displaying digital images in various manners. For example, they are able to display multiple images on corresponding display areas simultaneously. However, the display areas on display often have the same shape, which may be unappealing to many users. Therefore, what is needed is a digital photo frame capable of displaying images with various figures and a method thereof.

### BRIEF DESCRIPTION OF THE DRAWINGS

The components of the drawings are not necessarily drawn to scale, the emphasis instead being placed upon clearly illustrating the principles of the digital photo frame and the method thereof. Moreover, in the drawings, like reference numerals designate corresponding parts throughout several views.

FIG. 1 is a block diagram of a digital photo frame in accordance with an exemplary embodiment.

FIGS. 2 and 3 are a flowchart illustrating a method of displaying images with various figures implemented by the digital photo frame of FIG. 1 in accordance with an exemplary embodiment.

FIG. 4 is an exemplary schematic diagram illustrating an displaying process while a user selects system display mode.

FIG. 5 is an exemplary schematic diagram illustrating an displaying process while a user selects user-defined display mode.

### DETAILED DESCRIPTION

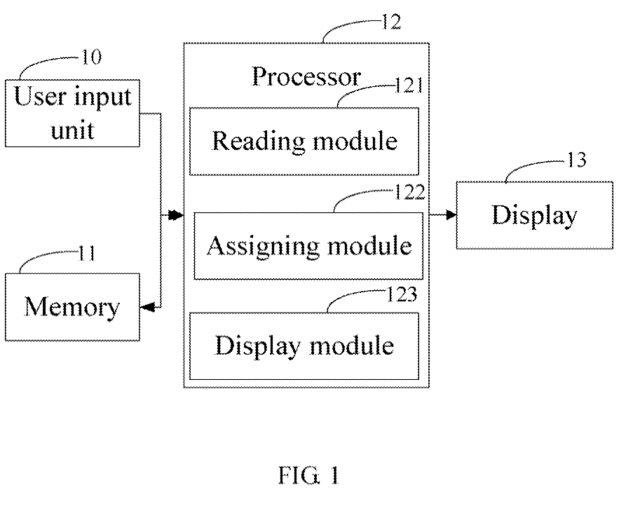

FIG. 1 is an exemplary block diagram of a hardware infrastructure of a digital photo frame in accordance with an exemplary embodiment. The digital photo frame includes at least one user input unit 10, a memory 11, a processor 12, and a display 13.

The memory 11 is configured for storing images, various frames, and display modes. Each of the display modes defines a total display area count of images displayable on the display 13, types of frames assigned to each display area, and a predetermined display manner. The frames may have different designs in shapes, sizes and patterns, and the types of frames in each display area can be the same. The display modes can also define parameters, such as ratio, brightness, color, and angle view of the image. The display modes can be system default and can also be configured using the user input unit 10.

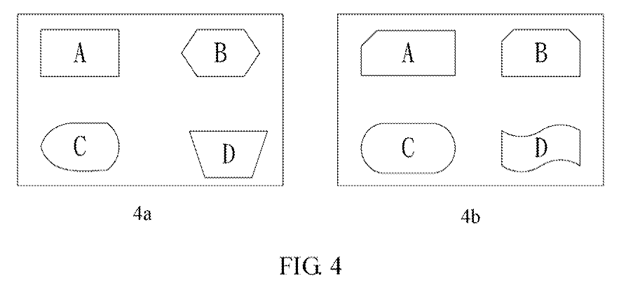

In an exemplary embodiment, system default display mode is defined as: the total count of the images displayable on the display 13 is 4, types of each display area are four types of all frames stored in the memory 11, and the display manner is the frame cycle manner, wherein the frame cycle manner is defined as: displaying an image in each display area firstly (see FIG. 4), not substituting the displayed image with another to-be-displayed image until all of assigned frames are used, the procedure will not ended until all images are displayed. For example, image A, B, C, and D are displayed in corresponding display area, the frame of each display are transformed continually, and the image of each display area will not be replaced until all defined types of frames are used.

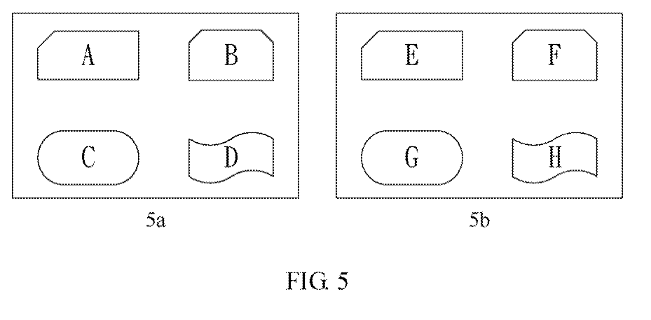

In the exemplary embodiment, the user-defined display mode is defined as: the total count of the images displayable on the display 13 is 4, types of each display area are any one of the frames stored in the memory 11, and the display manner is the image cycle manner, wherein the image cycle manner is defined as : firstly, assigning an frame in each display area (see FIG. 5), displaying an image in each display area, after an interval (e.g., 0.1 s), substituting the displayed image with another to-be-displayed image, not transforming the frame assigned in each display area until all images are displayed, and the procedure will not ended until all frames are used. For example, assigning an frame in each display area, and images A, B, C, and D are displayed in corresponding display areas, the image displayed in each display is replaced with another to-be-displayed images continually, and the frame assigned in each display area will not be replaced until all images displayed.

The processor 12, being connected to the memory 11 and the user input unit 10, includes a reading module 121, an assigning module 122, and a display module 123. The reading module 121 is configured for obtaining images and a display mode from the memory 11, and retrieving corresponding count of images and types of frame according to the display mode. The assigning module 122 is configured for defining one or more display areas on the display 13 according to the total display area count defined in the display mode, and assigning the display areas with different frames. The displaying module 123 is configured for displaying the images in the display areas assigned with different frames according to the display mode.

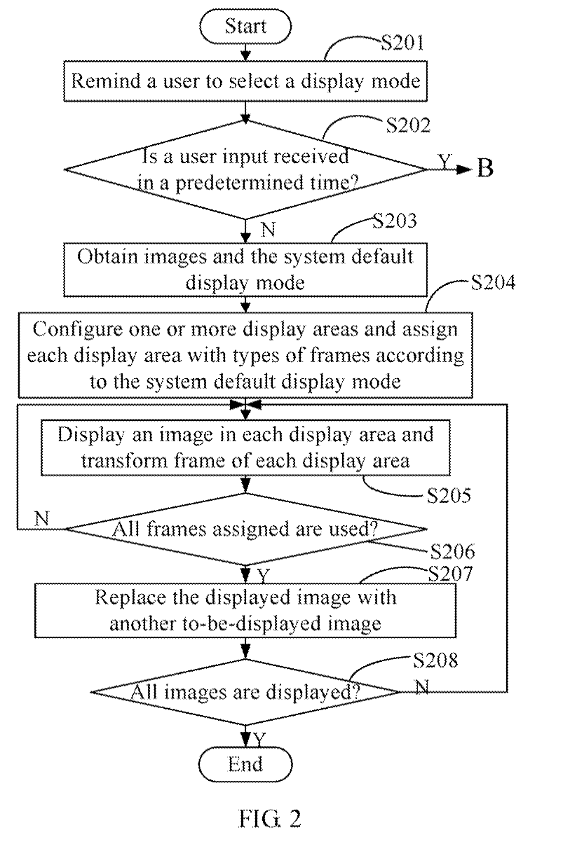

FIG. 2 is a flowchart illustrating a method of displaying images implemented by the digital photo frame 1 of FIG. 1.

In step S201, after being powered on, the digital photo frame reminds the user to select a display mode. For example, in the exemplary embodiment, the digital photo frame provides system default display modes and user-defined display modes for selection.

In step S202, the processor 12 determines whether it receives an operation instruction generated from the input unit 10 in a predetermined time, that is, the processor 12 determines whether the user selects a display mode in the predetermined time.

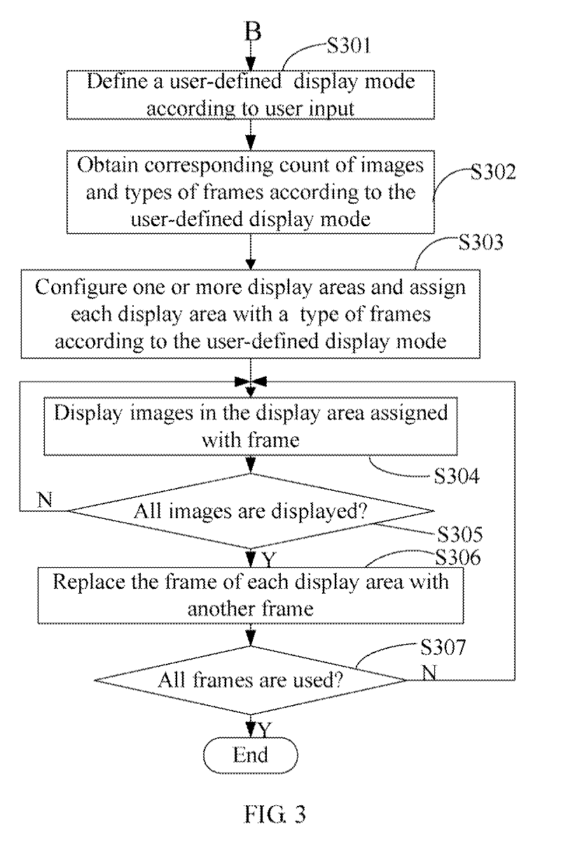

In step S203, if the processor 12 does not receive the operation information generated from the input unit 10, the reading module 121 obtains the system default display mode from the memory 11; and if the processor 12 receives the operation information, the procedure goes to B, a process shown by FIG. 3.

In step S204, the assigning module 122 configures one or more display areas and assign each display area with various frames in accordance with the system default display mode. In the exemplary embodiment, system default display mode defines that the total count of the images displayable on the display 13 is 4, types of each display area are any one of the frames stored in the memory 11, and the display manner is the frame cycle manner.

In step S205, the display module 123 displays an image in each display area, and transforms the frame of each display area.

In step S206, the display module 123 determines whether all frames assigned to each display area are used, if yes, the procedure goes to S207; and if not, the procedure returns to S205.

In step S207, the display module 123 replaces the displayed image in each display area with another to-be-displayed image.

In step S208, the display module 123 further determines whether there are to-be-displayed images, if yes, the procedure returns to S205; and if not, the procedure is ended.

FIG. 3 is a flowchart continuing the flowchart in FIG. 2 from point B, wherein there is a user input operation received in a predetermined time in step S202.

In step S301, the processor 12 determines that the user wants to manually define the display mode, the processor 12 defines parameters of the display mode according to the operation information from the user. For example, the user-defined display mode is defined as: the total count of the images displayable on the display 13 is 4, types of each display area are any one of the frames stored in the memory I 1, and the display manner is the image cycle manner. Additionally, types of frame assigned to each display area can also be one or more types selected from al frames stored in the memory 11 by user.

In step S302, the reading module 121 obtains corresponding count of images and types of frames from the memory 11 according to the user-defined display mode.

In step S303, the assigning module 122 configures one or more display areas and assigns each display area with a type of frame.

In step S304, the display module 123 display different images in each display area assigned with a type of frame.

In step S305, the display module 123 determines whether all images are displayed, if yes, the procedure goes to S306; and if not, the procedure returns to S304.

In step S306, the display module 123 replaces the frame of each display area with another frames.

In step S307, the display module 123 further determines whether all frames that defined by the user-defined display mode are used, if yes, the procedure is ended; and if not, the procedure returns to S304.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A digital photo frame for displaying images, comprising:
a display;
a user input unit;
a memory for storing images, types of frames, and display modes, wherein each of the display modes defines a total display area count of images displayable on the display, types of frames assigned to each display area, and a predetermined display manner; and
a processor connected with the memory, the user input unit and the display, comprising:
a reading module configured for obtaining images and the display modes from the memory;
an assigning module is configured for configuring one or more display areas on the display according to the total display area count defined in the display mode, and assigning the display areas with different frames; and
a displaying module configured for displaying the images in the display area assigned with different frames according to the display mode.

2. The digital photo frame as described in claim 1, wherein the predetermined display manner is selected from the group consisting of an image cycle manner, and a frame cycle manner.

3. The digital photo frame as described in claim 2, wherein the frame cycle manner is defined as: displaying an image in each display area firstly, not substituting the displayed image with another to-be-displayed image until all of assigned frames are used.

4. The digital photo frame as described in claim 2, wherein the image cycle manner is defined: firstly, assigning an frame in each display area, displaying an image in each display area, after an interval, substituting the displayed image with another to-be-displayed image, not transforming the frame assigned in each display area until all images are displayed.

5. The digital photo frame as described in claim 1, wherein the types of frames of each display area can be the same.

6. A method of adjusting image properties applied on a digital photo frame which comprises:
a user input unit;
a memory; and
a display,
the method comprising:
remind user to select a display mode;
obtaining images, frames, and the display mode from the memory;
configuring one or more display area in the display according to the display mode selected by a user from the user input unit, and assigning each display area with various frames; and
displaying images in the display areas assigned with different frames according to the display manner defined by the display mode.

7. The digital photo frame as described in claim 6, wherein the predetermined display manner is selected from the group consisting of an image cycle manner, and a frame cycle manner.

8. The digital photo frame as described in claim 7, wherein the frame cycle manner is defined as: displaying an image in each display area firstly, not substituting the displayed image with another to-be-displayed image until all of assigned frames are used.

9. The digital photo frame as described in claim 7, wherein the image cycle manner is defined: firstly, assigning an frame in each display area, displaying an image in each display area, after an interval, substituting the displayed image with another to-be-displayed image, not transforming the frame assigned in each display area until all images are displayed.
